(19) United States
(12) Patent Application Publication
(10) Pub. No.: US 2013/0238427 A1
(43) Pub. Date: Sep. 12, 2013

(54) Social Consumer Spheres

(71) Applicant: William H. Runyan, Austin, TX (US)

(72) Inventor: William H. Runyan, Austin, TX (US)

(73) Assignee: eBay, Inc., San Jose, CA (US)

(21) Appl. No.: 13/416,441

(22) Filed: Mar. 9, 2012

(51) Int. Cl. G06Q 30/02

(52) U.S. Cl. 705/14.49

(57) ABSTRACT

According to an embodiment, a method comprises providing, by a server, a platform including at least one group, wherein each group is associated with at least one product offered by one or more entities over a network, wherein each group is created by a leader user when the leader user is interested in a transaction associated with the product(s), and wherein the leader user decides to add one or more members to the group(s) for the associated product(s) based on one or more attributes of the member(s). The method also comprises displaying consumer data associated with the group(s), the leader user or the member(s). The method further comprises providing access to the one or more entities to the consumer data such that the one or more entities provide incentives to the group(s) associated with the product(s) to encourage the group(s) to complete the transaction associated with the product(s).

### BACKGROUND

1. Technical Field

Embodiments of the present disclosure generally relate to transactions over a network, and more particularly, to methods and systems for a social consumer spheres platform.

2. Related Art

Advertising is a multi-billion dollar centuries-old business. For decades, the physical attributes and “coolness” of actors and models used by corporations in their commercials and marketing propaganda have driven consumers to embrace a particular brand, product, or commodity. In this antiquated model, only the time of the actors and the corporations themselves are rewarded. The actors receive compensation for their time and attractiveness, while the corporations benefit from brand recognition, new consumer engagement, and sales conversion. Consumers, on the other hand, only get the product they purchased and perhaps a small discount from the corporation if coupons or other incentives are available.

In many instances, a unidirectional relationship has developed where the spending habits of consumers have been translated into multi billion dollar businesses by corporations. For example, recent rounds of funding have focused on identifying or extracting deep relationships from large datasets, which may only be focused on benefits provided to corporations, and not consumers.

Consumers may generally have immense influence over transactions such as purchasing decisions of those within and outside of their network. Most consumers trust the reviews left by complete strangers on websites such as Amazon.com™, Walmart.com™, BestBuy.com™, etc. Companies like Bazaarvoice™ and its competitors have built a business around capturing and exchanging reviews and other purchasing attributes between consumers and potential consumers. Consumers are willing to purchase product bundles or even products other than the one they originally planned to purchase all because a website displays, for example, “People that looked at this product also looked at XYZ”. The emergence and maturation of online reviews capturing, consumer segmentation, and dynamic content delivery has increased sales conversion, increased average purchase amount per consumers, and increased consumer traffic to both physical and online entities. Consumers may be influenced into purchasing products because of reviews or dynamic cross-selling. Consumers leave reviews that better inform other would-be consumers and thus drive sales conversion and profit for corporations. Before social commerce emerged and still to this day, commercial actors and actresses are compensated for their time, but the consumer's contributions are rarely recognized. At times, there are loyalty points or coupons delivered to the consumer for their purchases or reviews; however, more often than not, the consumer benefits little from their contribution.

### SUMMARY

As will be further described herein in relation to various embodiments, methods and systems are provided for a social consumer spheres platform.

In accordance with an embodiment of the disclosure, a method comprises providing, by a server, a platform including at least one group, wherein each group is associated with at least one product offered by one or more entities over a network, wherein each group is created by a leader user when the leader user is interested in a transaction associated with the product(s), and wherein the leader user decides to add one or more members to the group(s) for the associated product(s) based on one or more attributes of the member(s). The method also comprises displaying consumer data associated with the group(s), the leader user or the member(s). The method further comprises providing access to the one or more entities to the consumer data such that the one or more entities provide incentives to the group(s) associated with the product(s) to encourage the group(s) to complete the transaction associated with the product(s).

In accordance with another embodiment of the disclosure, a system for providing a social consumer spheres platform comprises a platform manager server that interacts with at least one user device and an entity device over a network. The system also includes one or more processors and one or more memories adapted to store a plurality of machine-readable instructions. When executed by the one or more processors, the machine-readable instructions are adapted to cause the system to: provide a platform including at least one social consumer sphere, wherein each social consumer sphere is associated with a specific product offered by an entity associated with the entity device, wherein each social consumer sphere is created by a leader user associated with the user device when the leader user is interested in a transaction associated with the specific product, and wherein the leader user decides to add one or more members to the social consumer sphere(s) for the specific product based on one or more attributes of the member(s); display consumer data associated with the social consumer sphere, the leader user or the member(s); and provide access to the entity to the consumer data such that the entity provides incentives to the social consumer sphere associated with the specific product to encourage the social consumer sphere to complete the transaction associated with the specific product.

In accordance with another embodiment of the disclosure, a user device includes one or more processors and one or more memories adapted to store a plurality of machine-readable instructions. When executed by the one or more processors, the machine-readable instructions are adapted to cause the user device to download a social consumer spheres application from a remote server; create a consumer profile that is supplemented by and stored in the remote server in a consumer database; create one or more social consumer spheres targeted at transactions associated with one or more corresponding specific products offered by one or more entities; and receive incentives associated with the transactions from the entities based on the consumer database.

These and other features and advantages of the embodiments of the present disclosure will be more readily apparent from the detailed description of the embodiments set forth below taken in conjunction with the accompanying drawings.

### BRIEF DESCRIPTION OF THE FIGURES

FIG. 1 is a diagram illustrating a social consumer spheres platform according to an embodiment of the present disclosure.

FIG. 2 is a flow diagram illustrating a method for participating by a consumer in a social consumer sphere platform according to an embodiment of the present disclosure.

FIG. 3 is a flow diagram illustrating a method for participating by an entity in a social consumer sphere platform according to an embodiment of the present disclosure.

FIG. 4 is a flow diagram illustrating a method for providing social consumer spheres according to an embodiment of the present disclosure.

FIG. 5 illustrates a block diagram of a social consumer spheres system using a platform manager according to an embodiment of the present disclosure.

FIG. 6 illustrates a block diagram of a system for implementing a device according to one embodiment of the present disclosure.

Like element numbers in different figures represent the same or similar elements.

### DETAILED DESCRIPTION

In accordance with various embodiments described herein, methods and systems provide a platform for one or more groups or social consumer spheres where each group or sphere is associated with a specific product identified by an interested consumer. A user or consumer may identify, specifically, an interest in a product offered by an entity over a network. Other users or consumers may see this interest and opt in to be members of a sphere for the specific product. The user may then become a leader who may control who gets let into the sphere, such as by seeing attributes of others who want in. Attributes may include, for example, publicly available information such as ratings, comments, etc. posted by the others.

In this way, a platform may include many spheres of the same or different products. In some embodiments, entities may pay a fee and access these spheres, including information about the consumers within each sphere. The entities may then make offers to members of a sphere. The offers may differ even with the same product. For example, a first sphere for a particular digital camera may have value members, for example, members who actively post ratings/comments/videos, with most being positive. A second sphere may have members of less value in comparison, for example, members who do not post frequently and/or post negatively. The first sphere may get a better offer.

Consumers may be able to select which private information is exposed to the leader and/or the entities. The platform manager may also offer data about consumers (such as transaction history) to the leader and/or the entities. The platform manager may be, for example, eBay® and/or Paypal® of San Jose, Calif.

It should be noted that a “product” may include, for example, any brand, commodity, item, service, subscription, application, or any other appropriate product offered over a network by one or more entities. Entities may include, for example, corporations, retailers, merchants, service providers, charities, subscription services or any other appropriate business entity, profit or nonprofit.

Advantageously, embodiments of the present disclosure may allow average consumers to monetize their spending habits, online and offline time investment, social graphs or any other appropriate consumer behaviors.

In today's online world, a consumer's demographics may be readily available through various Internet enabled services. Similarly, many consumers invest time cultivating and actively managing their online social network through various social media sites such as Facebook®, LinkedIn®, Google+®, MySpace®, and other sites. Additionally, consumers have a tremendous appetite for sharing their opinion as seen, for example, through Twitter®, Facebook Like's®, Google+1®, Blogs, the millions of comments on news sites, offline conversation, and other less visible areas of the Internet. All of these attributes may define a consumer, and these attributes may well define a consumer's power and influence over other potential consumers. It is possible that consumers may combine their demographics, social network size and quality, desire to share their opinion, how often another consumer found their reviews informative, and purchasing intent to negotiate incentives from entities such as retailers in return for access to their social network, product reviews, how-to videos, impromptu video-based product demos shared through YouTube®, raw purchases of retailers' products, and other consumer driven activities that benefit the retailer, a product manufacturer or any other entity.

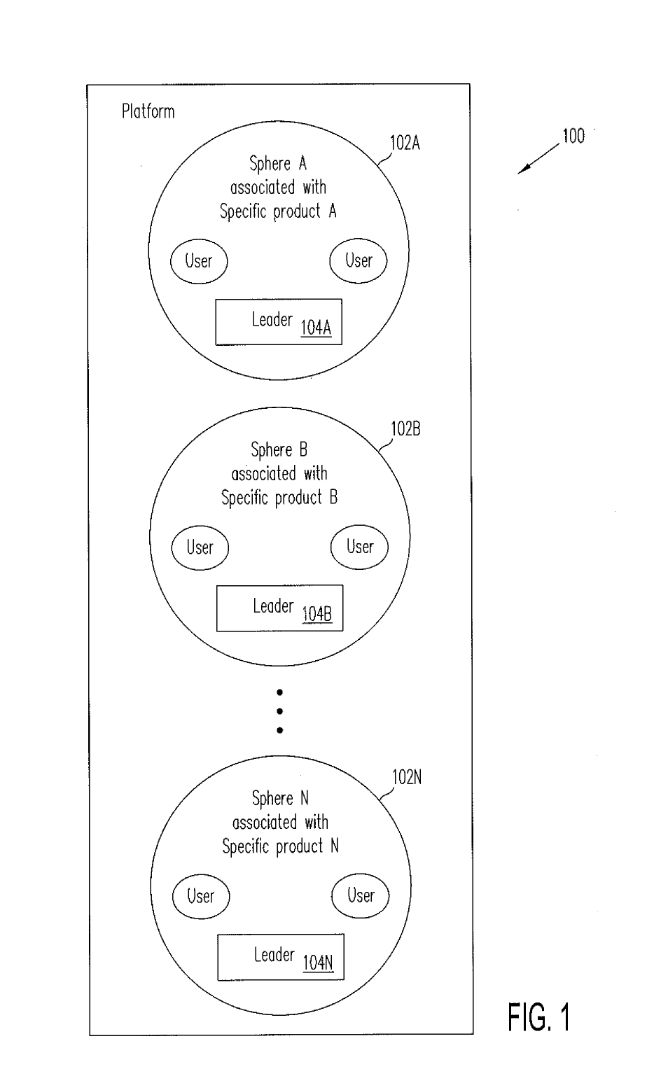

Referring now to the drawings wherein the showings are for purposes of illustrating embodiments of the present disclosure only, and not for purposes of limiting the same, FIG. 1 is a diagram illustrating a social consumer spheres platform according to an embodiment of the present disclosure.

A Social Consumer Spheres platform 100 allows consumers to organize themselves into one or more groups that may be called Consumer Spheres or Spending Spheres, which are illustrated in the embodiment of FIG. 1 as spheres 102A-102N, where N is a an integer number. The groups of each sphere 102A-102N identify themselves as interested in purchasing a particular product A-N, respectively. Particular products may include any product of a certain brand, price or model, for example, a particular product may be a Canon PowerShot™ digital camera, model X, a Sony Bravia™ 42″ television set, or any other product.

Each group has a respective leader 104A-104N. In some embodiments, the respective leader 104A-104N may appoint qualified consumers responsible for screening other consumers and refining an opt-in list to a set of trusted consumers that are also interested in purchasing the same product. Many criteria may go into the leader's decision for letting in other consumers into the sphere as members, including, for example, the other consumers' reputation on the platform, their history with making a purchase once they have opted into a sphere, the depth and quality of their social network, and other attributes that define their ability to attract consumers that will purchase the product when the right offer arrives. If the leader and the members are successful in, for example, converting the sphere to purchase, they may be rewarded with larger incentives or offerings, along with a ratings increase on platform 100, badges on the platform, and/or perhaps presence on a leaderboard.

In that regard, according to various embodiments, the leader and members of a sphere may have an associated profile that includes, for example, demographics characteristics, purchase conversion records, review contributions, referrals, and/or profile ratings depicting their level of contribution and even a dollar amount of transactions they helped complete.

Social Consumer Spheres platform 100 may be implemented on a server and may be managed by a platform manager such as PayPal® or Ebay®, Inc. of San Jose, Calif.

Social Consumer Spheres platform 100 may allow consumers to register their group and transaction intent such as a purchasing intent, and may allow entities such as retailers and product manufacturers of all shapes and sizes to offer the group the product they wish to purchase at a discount, with a coupon, or any other appropriate incentives, such as extended warranty, a product bundle, or additional loyalty points. Entities generally would not just offer incentives such as product discounts to any consumer spending sphere. Instead, the entities may start by analyzing the group's leader and his or her rating on the platform, for example. The leader rating may be based, for example, in part, on the leader's success at converting consumers to purchase. The entity may then analyze the depth and breadth of the consumers in the sphere and their history with expressing a transaction intent and then actually completing the transaction (e.g., making the purchase).

After a transaction such as a purchase is completed, the group may be invited, for example through incentives from the entity, to provide reviews and/or ratings for the product. Again, the invite to provide reviews and/or ratings may be fueled by data about the consumers and their likelihood to provide solid feedback that other consumers have voted up or “liked” at some point during their transaction experience. In other words, through the platform, entities may have the ability to see how effective the consumer's reviews were at influencing transaction or purchasing behavior in other consumers.

Instead of consumers simply volunteering their purchasing power and review contribution, consumers may have the power to monetize their online digital profile, including the time they spend maintaining their social network and reputation, their spending appetite and intent, and their willingness to provide product reviews. Regarding the power of consumers to monetize their digital profile, a few different things may be involved, for example: first, by organizing themselves into high-powered spending groups, they may receive incentives from retailers looking to drive the consumers to complete the purchase. Second, the Social Consumer Spheres platform may employ a “game” tactic where participation in the platform generates points and ratings for each participating consumer. A leader board may be crafted and thus display the value of consumers participating in the platform. This provides a non-currency monetization of the consumer by associating a ranking and value with the consumer's profile that is visible to their peers and thus increasing their “value” and reputation. Third, a consumer with a high ranking on the platform may be approached on the platform by other consumers and requested to put together a spending sphere. These “other” consumers may be members of the platform but may not have the clout to lure consumers into a sphere and/or entities to make an offer in that sphere. The leader may request an incentive from the group (coupon, dollar amount, etc.) for organizing the sphere and using his or her clout to help the floundering consumer.

According to one or more embodiments of platform 100, consumers may post their demographic characteristics, spending habits and recent purchases, open read-only access to their social network tree, indicate what products they are planning to purchase in the future, what reviews they have contributed to various sites in the past, and/or any other pertinent profile characteristics.

The demographics would be indisputable and come from a reputable source to avoid synthetic manufacturing by the consumer. Reviews that the consumer may have contributed elsewhere may also be linked to the consumer's profile so that they could not be spoofed. Also, a social network may define the consumers along with their depth and breadth of reach into various consumer domains and demographics. For example, the consumer's LinkedIn™ account would depict if the consumer is an Executive and thus knows other Executives or if the consumer resides in another tier of the corporate hierarchy. On Facebook™, the consumer may be found to interact most often with mothers for organizing kids play-dates. This type of LinkedIn™ profile or Facebook™ activity would may the entities to engage the consumer in one way or another. In some embodiments, the social network may also provide the entity a glimpse into the consumer's physical attributes, which may, for example, ensure they fit the “look” they are seeking. This data may allow the entity to solicit and incentivize reviews and even purchases from consumers that are proven to generate the most traffic and conversion while having the largest sphere of not just social influence but the “right” social influence. As the consumer collects successful purchase conversion records, review contributions, and referrals, their profile earns “badges” or “ratings” depicting their level of contribution and even a dollar amount of the sales they helped fuel. As such, a social network may be reshaped into a network such as a “Purchasing and Consumer Influence Network”.

As such, according to embodiments herein, consumers may monetize their online and offline purchasing time. Currently, big data, social graphs, ratings and reviews, and other parts of the commerce experience are generally being mined exclusively to benefit entities such as retailers and large corporations. According to one or more embodiments of the present disclosure, a consumer may be rewarded for his or her time and recognized by his or her peers and other entities for doing so.

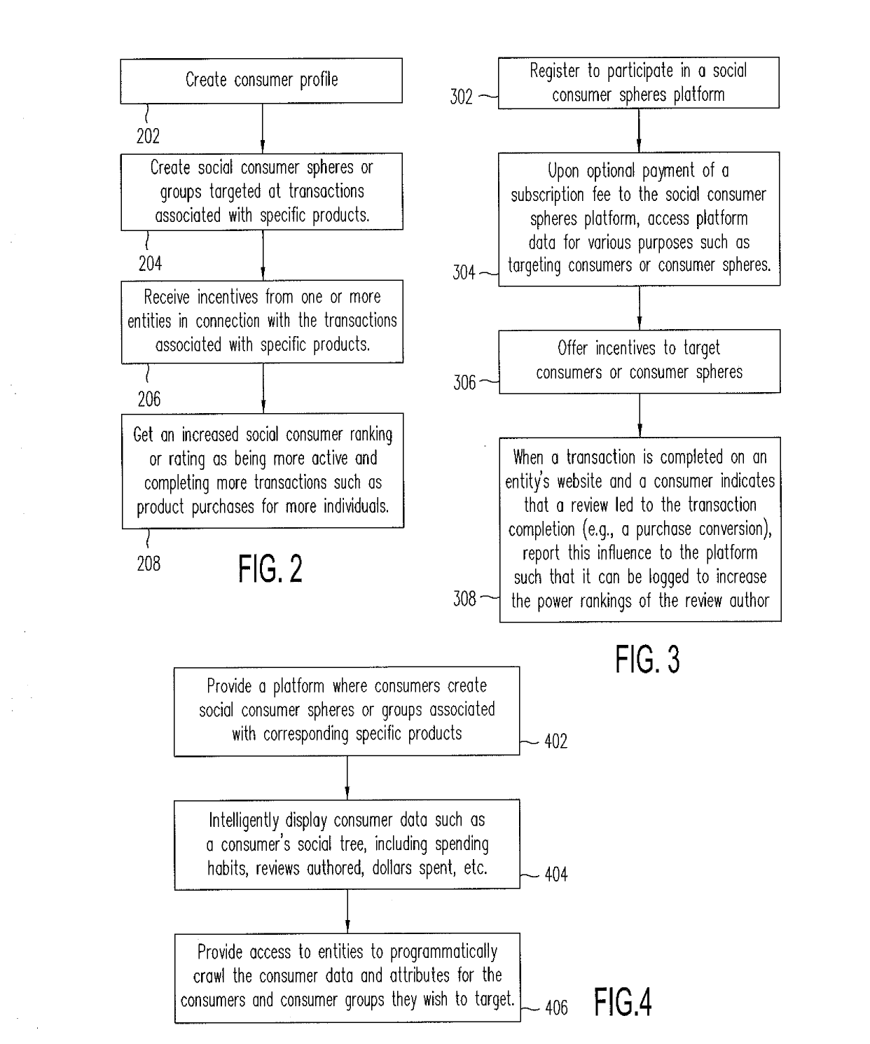

Referring now to FIG. 2, a flow diagram illustrates a method for participating by a consumer in a social consumer sphere platform according to an embodiment of the present disclosure. It should be noted that the method of FIG. 2 may be implemented by the platform illustrated in FIG. 1 according to an embodiment.

In block 202, a consumer may create a profile on a social consumer spheres platform. In one or more embodiments, the consumer may download an application from a platform manager on a user device (e.g., a mobile device, a notebook computer, a tablet, or the like) for accessing the platform and creating the consumer profile. In that regard, the consumer may upload a picture, age, location, hobbies, links to recent reviews, links to recent purchases, links to his or her Social networks (e.g., Facebook®, Google+®, LinkedIn®, etc.), links to his or her blogs or other online contributions, and any other information appropriate for a consumer profile.

In addition, the social consumer spheres platform may supplement the consumer's profile by adding features, including, for example, demographics captured from authentic online services, number of times the consumer's reviews have been “Liked” or marked “Useful”, and/or credit or transaction history of the consumer.

In block 204, the consumer may create or register one or more groups or social consumer spheres associated with one or more products. For instance, the consumer may create a group or social consumer sphere targeted at purchasing a single product such as a specific digital camera of a certain brand, model or features. According to embodiments herein, the consumer may have the ability to organize and be a leader of mass purchase groups (spheres or circles) where other consumers in and adjacent to his or her social tree may opt in to indicate their desire to purchase the product contained within the sphere. The leader of the purchasing sphere has the ability to decline a consumer's request to join the sphere and may do so based on various attributes including, for example, the consumer's social network quality, his or her purchase history, and data that describes how often he or she indicates a desire to purchase but fails to convert. Consumer registration may be free.

In block 206, incentives are received from one or more entities in connection with the transactions associated with specific products. The social consumer sphere creator, leader or organizer may be rewarded when individuals in the social consumer sphere or group complete the transaction (e.g., make the purchase) using an incentive such as an incentive code provided by an entity such as a retailer. In this regard, depending on the size of the sphere, an entity optionally decides to incentivize the group or members of the sphere to convert on the purchase. The entity may then provide an incentive to the circle such as making an offer for a discount and inviting purchase conversion while rewarding the original organizer with a larger incentive. The entity may pay a subscription fee to search the consumers contained within the platform.

In block 208, the consumer's social consumer ranking increases as the consumer is more active and converts sales for more individuals. The consumer's ranking may be visible, for example, through a dashboard in the platform. In one embodiment, a dashboard may include a list of consumers displayed on a website sorted in order from 1 through N. Sorting may be based on how many spheres they have led and total quantity of sales that occurred as a result. Another 1 through N dashboard may display and sort consumers by the dollar amount all of the sales their spheres have influenced.

Referring to FIG. 3, a flow diagram illustrates a method for participating by an entity in a social consumer sphere platform according to an embodiment of the present disclosure. It should be noted that the method of FIG. 3 may be implemented by the platform illustrated in FIG. 1 according to an embodiment.

In block 302, an entity may register and participate in a social consumer sphere platform. In one or more embodiments, the entity may pay a subscription fee to search data associated with consumers or groups or spheres included within the platform.

In block 304, upon the entity's optional payment of the subscription fee to the social consumer sphere platform, the entity may access platform data for various purposes such as targeting consumers or consumer spheres. For example, the entity may search consumer profiles and solicit them for reviews. Also, the entity may be able to conduct intricate searches of the platform data to find consumers and consumer spheres the entity wishes to target. This data includes, for example, demographic data, social trees, professional trees, spending habits, reviews authoring, reviews usage, and other rich information about the consumer. In addition, the entity may be able to solicit specific consumers to assist in an advertising campaign. The solicitation may be based on the consumer's “value” in the platform. Furthermore, an entity such as a retailer may have the ability to solicit a manufacturer using the rich set of data they have found to partner with them on an incentive program. It should be understood that many other advantages to the entity may be available upon registering and participating in the platform.

In block 306, the entity may offer incentives to target consumers or consumer spheres. For example, the entity may offer discounts, coupons, extended warranties, or other incentives to consumers or members of a sphere. In various embodiments, the entity may offer incentives to various consumers or spheres based on their value or rating in the platform. For example, the entity may offer better incentives (e.g., a higher percentage discount such as 50% off) to consumers having a higher ranking on the platform based on, for example, a high purchase conversion, positive reviews, or high influence on other consumers, than to consumers having a lower ranking or value in the platform (e.g. a lower percentage discount such as 20% off) for the same or different products.

In block 308, when a transaction such as a purchase is completed from the entity, and a consumer indicates that a review led to the purchase conversion, the entity may report this influence to the platform such that it can be logged to increase the power rankings of the review author consumer. In various embodiments, through use of a network, integration techniques, and related technologies, the platform may be programmatically notified such that it does not require user intervention.

Referring to FIG. 4, a flow diagram illustrates a method for providing a social consumer sphere platform according to an embodiment of the present disclosure. It should be noted that the method of FIG. 3 may be implemented by the platform illustrated in FIG. 1 according to an embodiment.

In block 402, a social consumer spheres platform is provided to allow a consumer to create one or more groups (e.g., spheres or circles) each one associated with a specific product. In an embodiment, the platform may provide an application that may be downloaded by a consumer on a user device (e.g., a mobile device, tablet, notebook, etc). Consumers may upload consumer profiles including data provided by or linked to by the consumer. In addition, the platform may supplement the consumer profiles by adding features, including, for example, demographics captured from authentic online services, number of times the consumer's reviews have been “Liked” or marked “Useful”, and/or credit or transaction history of the consumer. As described above according to one or more embodiments, each sphere or group may have a leader (or delegate) who may evaluate and decide whether to let in other users that express interest in the same product or sphere to become members of the sphere.

In block 404, the platform may display consumer data or consumer attributes including, for example, the consumer's social tree, spending habits, reviews authored, dollars spent, etc. In one embodiment, for example as illustrated in FIG. 1, consumer data for specific consumers may be accessed on platform 100 by selecting an interface or a link for a consumer or leader of a sphere (for example, labeled “user” or “leader” in FIG. 1), each of which may be associated or linked with his or her corresponding consumer data or attributes. In one or more embodiments, entities and/or other consumers may search for a consumer having particular characteristics, for example a single data point or attribute such as consumers having a positive review authored, or a combination of data points or attributes such as consumers having a positive reviews authored plus a minimum dollar amount spent. It should be understood that any single data point or combination thereof may be searchable by an entity or by another consumer and displayed in response to, for example, appropriate search terms.

In block 406, the platform may use programmatically exposed APIs that allow, for example entities such as subscription-paying entities, to programmatically crawl the consumer population or database and attributes for the consumers and consumer groups or spheres they wish to target.

According to an embodiment, the platform may disallow searching the consumer population or database unless a subscription fee is paid.

In one or more embodiments, the platform may allow a social site application, for example, a Facebook™ application that brings the consumer's social consumer spheres into the native Facebook™ experience, or a Google+™ application that brings the consumer's social consumer spheres into the native Google+™ experience. As such, the platform provides the ability to consumers to post a new product sphere to his or her Facebook™, MySpace™, Google+™, LinkedIn™, FourSquare™, or other social accounts.

In various embodiments review engines such as Bazaarvoice™, Open Social™, and other review platforms may be integrated such that reviews left by users in these engine platforms are also posted (content or quantity) to the social consumer sphere platform.

In other embodiments, an application may be downloaded to a user device (e.g. mobile device, tablet, notebook, etc) that allows a consumer to scan a product UPC (or enter it) and immediately construct a spending sphere from it followed by blasting the consumer's network with its creation.

Furthermore, in one or more embodiments, integration with emerging online wallets may be provided such that transactions through the online wallets may be reflected in the platform to begin building the consumer's spending history and habits. These can then be searched by entities or other consumers, for example by using appropriate search terms.

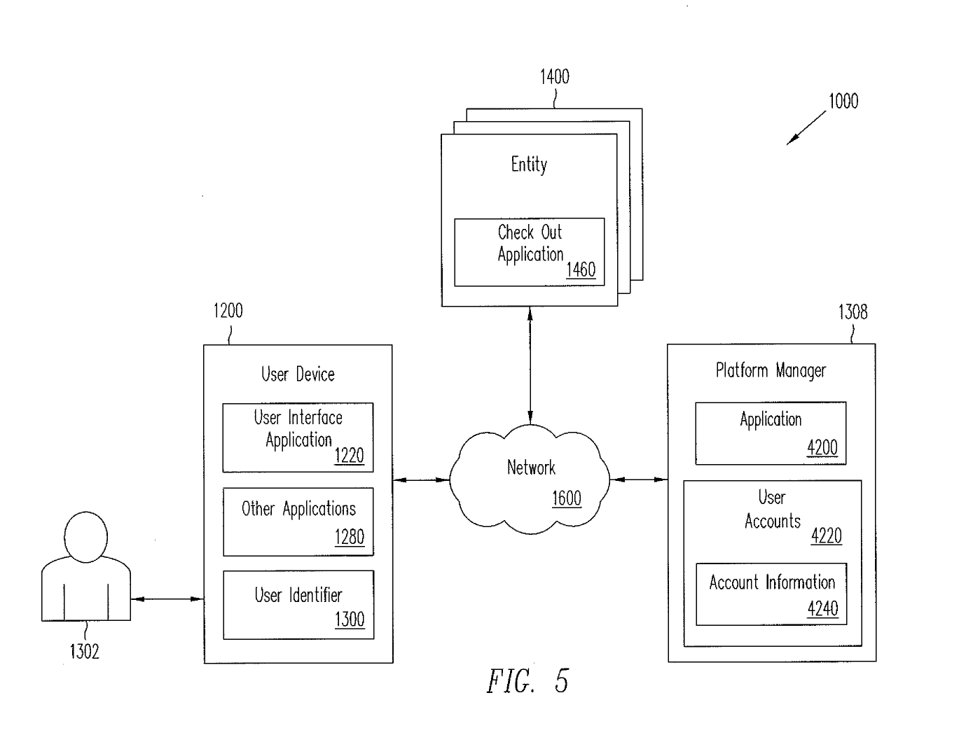

FIG. 5 illustrates a block diagram of a social consumer spheres system using a platform manager according to an embodiment of the present disclosure.

FIG. 5 shows one embodiment of a block diagram of a system 1000 adapted to provide a social consumer spheres platform over a network 1600. As shown in FIG. 5, the system 1000 includes at least one user device 1200 (e.g., network computing device), one or more entity devices 1400 (e.g., network server devices), and at least one platform manager device 1308 (e.g., network server device) in communication over the network 1600.

The network 1600, in one embodiment, may be implemented as a single network or a combination of multiple networks. For example, in various embodiments, the network 1600 may include the Internet and/or one or more intranets, landline networks, wireless networks, and/or other appropriate types of communication networks. In another example, the network 1600 may comprise a wireless telecommunications network (e.g., cellular phone network) adapted to communicate with other communication networks, such as the Internet. As such, in various embodiments, the user device 1200, entity servers 1400, and platform manager 1308 may be associated with a particular link (e.g., a link, such as a URL (Uniform Resource Locator) to an IP (Internet Protocol) address).

The user device 1200, in various embodiments, may be implemented using any appropriate combination of hardware and/or software configured for wired and/or wireless communication over the network 1600. In various examples, the user device 1200 may be implemented as a wireless telephone (e.g., cellular or mobile phone), a personal digital assistant (PDA), a tablet, a personal computer or desktop, a notebook computer, a television set, a game console, a DVR and/or various other generally known types of wired and/or wireless computing devices. It should be appreciated that the user device 1200 may be referred to as a client device or a customer device without departing from the scope of the present disclosure.

The user device 1200, in one embodiment, includes a user interface application 1220, which may be utilized by a user 1302 to conduct one or more transactions (e.g., shopping, purchasing, bidding, etc.) over the network 1600. For example, the user interface application 1220 may be implemented as a product selection application to track, manage, and store information related to the purchase of items, products, and/or services over the network 1600. In one aspect, purchase expenses may be directly and/or automatically debited from an account related to the user 1302 via the user interface application 1220.

In one implementation, the user interface application 1220 comprises a software program, such as a graphical user interface (GUI), executable by a processor that is configured to interface and communicate with the platform manager 1308 via the network 1600. In another implementation, the user interface application 1220 comprises a browser module that provides a network interface to browse information available over the network 1600. For example, the user interface application 1220 may be implemented, in part, as a web browser to view information available over the network 1600. In another example, the user 1302 is able to access entity websites, such as merchant websites, via the one or more entity servers 1400 to view and select products for purchase, and the user 1302 is able to purchase products from the one or more entity servers 1400. Accordingly, the user 1302 may conduct transactions (e.g., purchase and provide payment for products) from the one or more entity servers 1400 via, for example, a payment service provider server. In various embodiments, the payment service provider server may be associated with platform manager 1308.

The user device 1200, in various embodiments, may include other applications 1280 as may be desired in one or more embodiments of the present disclosure to provide additional features available to the user 1302. In one example, such other applications 1280 may include security applications for implementing client-side security features, programmatic client applications for interfacing with appropriate application programming interfaces (APIs) over the network 1600, and/or various other types of generally known programs and/or software applications. In still other examples, the other applications 1280 may interface with the user interface application 1220 for improved efficiency and convenience.

According to an embodiment, the other applications 1280 include an application that may be loaded on user device 1200 by platform manager 1308. Such application may enable user 1302 to create groups or social consumer spheres associated with one or more products according to one or more embodiments herein. In other embodiments, platform manager 1308 may be associated with a payment service provider, such that an application may also be loaded on user device 1200 by platform manager 1308 so that user 1302 may easily make payments for products over user device 1200.

The user device 1200, in one embodiment, may include at least one user identifier 1300, which may be implemented, for example, as operating system registry entries, cookies associated with the user interface application 1220, identifiers associated with hardware of the user device 1200, or various other appropriate identifiers. The user identifier 1300 may include one or more attributes related to the user 1302, such as personal information related to the user 1302 (e.g., one or more user names, passwords, photograph images, biometric ids, addresses, phone numbers, etc.) and banking information or funding sources (e.g., one or more banking institutions, credit card issuers, user account numbers, security data and information, etc.). In various implementations, the user identifier 1300 may be passed with a user login request to the platform manager 1308 via the network 1600, and the user identifier 1300 may be used by the platform manager 1308 to associate the user 1302 with a particular user account maintained by the platform manager 1308. In various embodiments, the platform manager 1308 may use a username and password or other authentication technique such that user data may be protected.

The one or more entity servers 1400, in various embodiments, may be maintained by one or more entities (e.g., merchant sites, resource information sites, utility sites, real estate management sites, social networking sites, charity sites, publications sites, etc.) offering various products for purchase and payment.

Each of the entity servers 1400, in one embodiment, may include a marketplace application, which may be configured to provide information over the network 1600 to the user interface application 1220 of the user device 1200. For example, the user 1302 may interact with the marketplace application through the user interface application 1220 over the network 1600 to search and view various products available for purchase in a database maintained by an entity.

Each of the entity servers 1400, in one embodiment, may include a checkout application 1460, which may be configured to facilitate online transactions (e.g., purchase transactions) by the user 1302 of products identified by the marketplace application. As such, in one aspect, the checkout application 1460 may be configured to accept payment information from the user 1302 over the network 1600.

Each of the entity servers 1400, in one embodiment, may include at least one entity identifier, which may be included as part of the one or more products made available for purchase so that, e.g., particular products are associated with particular entities. In one implementation, the entity identifier may include one or more attributes and/or parameters related to the entity, such as business and banking information. As described above, the user 1302 may conduct transactions (e.g., selection, purchasing, and/or providing payment for products) with each entity server 1400, for example via a payment service provider server associated with platform manager 1308 over the network 1600.

The platform manager 1308, in one embodiment, may be maintained by a transaction processing entity, which may provide processing for online financial transactions and/or information transactions between the user 1302 and one or more of the entity servers 1400. As such, the platform manager 1308 includes a service application, which may be adapted to interact with each user device 1200 and/or each entity server 1400 over the network 1600 to facilitate the selection, purchase, and/or payment of products by the user 1302 from one or more of the entity servers 1400. In one example, the platform manager 308 may be a server provided by PayPal, Inc. and/or eBay of San Jose, Calif., USA.

The service application, in one embodiment, utilizes a payment processing module to process purchases and/or payments for financial transactions between the user 1302 and each of the entity servers 1400. In one implementation, the payment processing module assists with resolving financial transactions through validation, delivery, and settlement. As such, the service application in conjunction with the payment processing module settles indebtedness between the user 1302 and each of the entity servers 1400, wherein accounts may be directly and/or automatically debited and/or credited of monetary funds in a manner as accepted by the banking industry.

The platform manager 1308, in one embodiment, may be configured to maintain one or more user accounts and entity accounts in an account database 4220, each of which may include account information 4240 such as a consumer database associated with one or more individual users (e.g., user 1302) and entities (e.g., one or more merchants associated with entity servers 1400). For example, account information 4240 may include private financial information of each user 1302 and each entity associated with the one or more entity servers 1400, such as one or more account numbers, passwords, credit card information, banking information, or other types of financial information, which may be used to facilitate online financial transactions between the user 1302 and the one or more entities associated with the entity servers 1400. In various aspects, the methods and systems described herein may be modified to accommodate users and/or entities that may or may not be associated with at least one existing user account and/or recipient account, respectively.

In one implementation, the user 1302 may have identity attributes stored with the platform manager 1308, and the user 1302 may have credentials to authenticate or verify identity with the platform manager 1308. User attributes may include personal information and/or banking information, as previously described. In various aspects, the user attributes may be passed to the platform manager 1308 as part of a login, selection, purchase, and/or payment request, and the user attributes may be utilized by the platform manager 1308 to associate the user 1302 with one or more particular user accounts maintained by the platform manager 1308. Also, as described above according to one or more embodiments, the user attributes may be used by the platform manager 1308 to create a consumer database that may be searched by one or more entities or other consumers, for example, by using appropriate search terms.

Although various components and steps have been described herein as being associated with user device 1200, one or more entity servers 1400, and platform manager 1308 of FIG. 5, it is contemplated that the various aspects of such servers illustrated in FIG. 5 may be distributed among a plurality of servers, devices, and/or other entities.

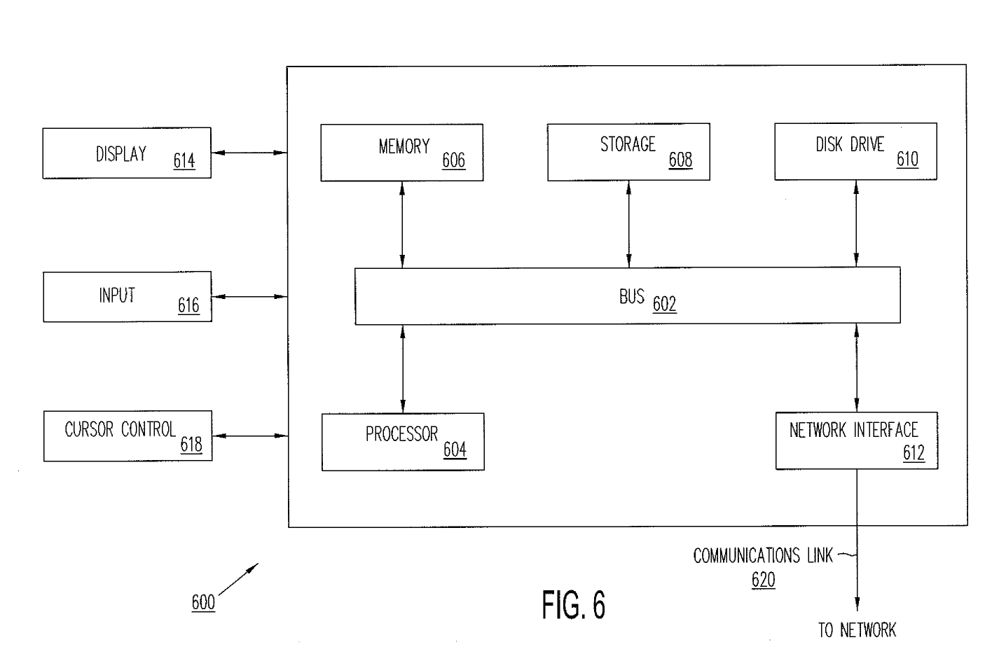

Referring now to FIG. 6 a block diagram of a system for implementing a device is illustrated according to one embodiment of the present disclosure.

FIG. 6 is a block diagram of a system 600 suitable for implementing embodiments of the present disclosure, including user device 1200, one or more entity servers or devices 1400, and platform manager 1308 server or device. System 600, such as part of a cell phone, personal computer and/or a network server, includes a bus 602 or other communication mechanism for communicating information, which interconnects subsystems and components, including one or more of a processing component 604 (e.g., processor, micro-controller, digital signal processor (DSP), etc.), a system memory component 606 (e.g., RAM), a static storage component 608 (e.g., ROM), a network interface component 612, a display component 614 (or alternatively, an interface to an external display), an input component 616 (e.g., keypad or keyboard), and a cursor control component 618 (e.g., a mouse pad).

In accordance with embodiments of the present disclosure, system 600 performs specific operations by processor 604 executing one or more sequences of one or more instructions contained in system memory component 606. Such instructions may be read into system memory component 606 from another computer readable medium, such as static storage component 608. These may include instructions to create accounts, process financial transactions, make payments, etc. In other embodiments, hard-wired circuitry may be used in place of or in combination with software instructions for implementation of one or more embodiments of the disclosure.

Logic may be encoded in a computer readable medium, which may refer to any medium that participates in providing instructions to processor 604 for execution. Such a medium may take many forms, including but not limited to, non-volatile media, volatile media, and transmission media. In various implementations, volatile media includes dynamic memory, such as system memory component 606, and transmission media includes coaxial cables, copper wire, and fiber optics, including wires that comprise bus 602. Memory may be used to store visual representations of the different options for payments or financial transactions. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 600. In various other embodiments, a plurality of systems 600 coupled by communication link 620 (e.g., network 1600 of FIG. 5, LAN, WLAN, PTSN, or various other wired or wireless networks) may perform instruction sequences to practice the disclosure in coordination with one another. Computer system 600 may transmit and receive messages, data, information and instructions, including one or more programs (i.e., application code) through communication link 620 and communication interface 612. Received program code may be executed by processor 604 as received and/or stored in disk drive component 610 or some other non-volatile storage component for execution.

In view of the present disclosure, it will be appreciated that various methods and systems have been described according to one or more embodiments for providing a social consumer spheres platform.

Where applicable, various embodiments provided by the present disclosure may be implemented using hardware, software, or combinations of hardware and software. Also where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the spirit of the present disclosure. In addition, where applicable, it is contemplated that software components may be implemented as hardware components, and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. It is contemplated that various alternate embodiments and/or modifications to the present disclosure, whether explicitly described or implied herein, are possible in light of the disclosure.

Having thus described embodiments of the disclosure, persons of ordinary skill in the art will recognize that changes may be made in form and detail without departing from the scope of the disclosure. Thus the disclosure is limited only by the claims.

What is claimed is:

1. A method comprising:
providing, by a server, a platform including at least one group, wherein each group is associated with at least one product offered by one or more entities over a network, wherein each group is created by a leader user when the leader user is interested in a transaction associated with the product(s), and wherein the leader user decides to add one or more members to the group(s) for the associated product(s) based on one or more attributes of the member(s);
displaying consumer data associated with the group(s), the leader user or the member(s); and
providing access to the one or more entities to the consumer data such that the one or more entities provide incentives to the group(s) associated with the product(s) to encourage the group(s) to complete the transaction associated with the product(s).

2. The method of claim 1, wherein the member(s) of the group(s) further comprise users other than the leader user that have a specific interest in the product and opt in to be members of the group(s) for the product.

3. The method of claim 2, wherein the leader user controls who gets let in to the group(s) based on the attribute(s) of the other users who want to opt in.

4. The method of claim 3, wherein the attribute(s) further comprise ratings, comments, or other publicly available information posted by the other users.

5. The method of claim 1, wherein the platform further comprises groups of the same or different products.

6. The method of claim 5, wherein the incentives differ with respect to the same product, wherein if a first group for a specific product has value members, the first group gets better incentives in comparison to a second group that has members who have less value members.

7. The method of claim 1, further comprising receiving payment from the one or more entities to access the consumer data including information about the group(s) as well as information about one or more members within each group.

8. The method of claim 1, further comprising receiving selections by the member(s) on which private information is exposed to the leader user and/or the entities.

9. The method of claim 1, further comprising configuring the platform such that the platform offers consumer data about the leader user or the member(s) of the groups) based on a single attribute or on a combination of attributes thereof.

10. The method of claim 1, wherein the platform provides a rating to the leader user based on his or her consumer behavior.

11. The method of claim 1, further comprising receiving requests from subscription-paying entities to programmatically crawl the consumer database and attributes for the group(s), the leader user or member(s) they wish to target.

12. The method of claim 1, further comprising providing the group(s) into a social site application that brings the group(s) into a native social site experience.

13. The method of claim 1, further comprising providing a downloadable platform application for a user device.

14. A system for providing a social consumer spheres platform, the system comprising:
a platform manager server that interacts with at least one user device and an entity device over a network;
one or more processors; and
one or more memories adapted to store a plurality of machine-readable instructions which when executed by the one or more processors are adapted to cause the system to:
provide a platform including at least one social consumer sphere, wherein each social consumer sphere is associated with a specific product offered by an entity associated with the entity device, wherein each social consumer sphere is created by a leader user associated with the user device when the leader user is interested in a transaction associated with the specific product, and wherein the leader user decides to add one or more members to the social consumer sphere(s) for the specific product based on one or more attributes of the member(s);
display consumer data associated with the social consumer sphere, the leader user or the member(s); and
provide access to the entity to the consumer data such that the entity provides incentives to the social consumer sphere associated with the specific product to encourage the social consumer sphere to complete the transaction associated with the specific product.

15. The system of claim 14, wherein the machine-readable instructions when executed by the one or more processors are further adapted to receive payment from the entity to access the consumer data.

16. The system of claim 14, wherein the machine-readable instructions when executed by the one or more processors are further adapted to provide social consumer spheres of the same product, wherein the incentives differ with respect to the same product, wherein if a first group for the specific product has value members, the first group gets better incentives in comparison to a second group that has members who have less value members.

17. The system of claim 14, wherein the machine-readable instructions when executed by the one or more processors are further adapted to provide a rating to the leader user based on his or her consumer behavior.

18. A user device comprising:
one or more processors; and
one or more memories adapted to store a plurality of machine-readable instructions which when executed by the one or more processors are adapted to cause the user device to:
download a social consumer spheres application from a remote server;
create a consumer profile that is supplemented by and stored in the remote server in a consumer database;
create one or more social consumer spheres targeted at transactions associated with one or more corresponding specific products offered by one or more entities; and
receive incentives associated with the transactions from the entities based on the consumer database.

19. The user device of claim 18, wherein the machine-readable instructions when executed by the one or more processors are adapted to add one or more members to the social consumer spheres based on attributes of the one or more members.

20. The user device of claim 18, wherein the machine-readable instructions when executed by the one or more processors are adapted to receive a rating based on the consumer profile.
